(19) United States
(12) Patent Application Publication
(10) Pub. No.: US 2016/0295888 A1
(43) Pub. Date: Oct. 13, 2016

(54) IMPROVED GELATINE COMPOSITION

(71) Applicant: ROUSSELOT B.V., Son (NL)

(72) Inventors: Paul Stevens, Gent Mendonk (BE); Claude Capdepon, Neuville En Ferrain (FR); Ivo Jozef Georges Simonne Verheye, Vinkt (BE)

(21) Appl. No.: 15/036,144

(22) PCT Filed: Nov. 14, 2014
(86) PCT No.: PCT/NL2014/050788

§ 371 Date: May 12, 2016

(30) Foreign Application Priority Data
Nov. 14, 2013 (NL) 2011803

(51) Int. Cl. A23L 1/05

(52) U.S. Cl. CPC A23L 1/05625; A23L 1/06; A23L 1/059; A23V 2002/00

(57) ABSTRACT

The invention relates to a gelatine composition, comprising gelatin, capable of being dissolved in water having a temperature of 35° C. or less to a solution of at least 10 w/w % and polyphosphate, to the use of such gelatine composition, to a food product comprising the composition, to a method for the preparation of such a gelatine comprising composition, and to a method for the preparation of such a food product.

The invention relates to a gelatine composition, to the use of such gelatine composition, to an edible product comprising the composition, to a method for the preparation of such a gelatine comprising composition and to a method for the preparation of such an edible product.

Gelatine is a mixture of water soluble proteins, derived from collagen. Gelatine is obtained e.g. by partial hydrolysis of collagen, obtained by aqueous extraction of skin, tendons, ligaments, bones etc. in acid or alkali conditions. Gelatine obtained by acid treatment is called Type A gelatin, whereas Type B gelatine is derived from alkali treatment. Gelatine is commonly used as gelling agent in food, pharmaceuticals and cosmetics.

The strength of a gelatine gel can be determined by a Bloom gelometer, and is indicated by a Bloom number. The test was originally developed in 1925 by O. T. Bloom (U.S. Pat. No. 1,540,979 and U.S. Pat. No. 2,119,699). The test determines the weight (in grams) needed by a probe (normally with a diameter of 0.5 inch) to deflect the surface of the gel 4 mm without breaking it. The result is expressed in Bloom (grades). It is usually between 30 and 300 Bloom. The higher the Bloom number, the stronger the gel. To perform the Bloom test on gelatin, a 6.67% gelatine solution is made at 60° C., then kept for 17-18 hours at 10° C. prior to being tested. The term low Bloom' reflects a Bloom number of 50-150, whereas ‘Medium Bloom’ reflects a Bloom number of 150-225, and ‘High Bloom’ reflects a Bloom number of 225-325.

Gelatine is used in many edible products as a stabilizer, thickener or texturizer. Because of the gelling (setting) properties, gelatine is easy to handle and can be used in food processing. In order to prepare a gelatine solution, dry gelatine is dissolved in hot water, i.e. of a temperature of 60° C. During the said food processing, the gelatine can be allowed to form a gel, i.e. to set, for example by lowering the temperature for a certain time period. It is known that the setting rate is affected by pH. Also so called ‘cold soluble’ gelatine is known, that can be dissolved at a temperature of below 35° C., in particular below 30° C. Aqueous solutions having a gelatine concentration of up to 10 w/w % or more, in particular of up to 15 w/w/%, up to 20 w/w % or even up to 25 w/w or higher can be prepared with such cold soluble gelatin. Cold soluble gelatine is e.g. used for products that do not allow a usual temperature of 60-65° where gelatine is dissolved. The skilled person is aware of method as to how to produce cold soluble gelatin, see e.g. U.S. Pat. No. 2,841,498. However drying techniques, such as drum drying have become available to the skilled person in order to produced cold soluble gelatin. An example of cold soluble gelatine available on the market is Gelita® Instant Gelatine. In contrast to conventional gelatine that dissolves at 60° C., which has an at least partially crystalline structure, the cold soluble gelatine is amorphous.

In the art, edible products, in particular non-aerated edible products are known to comprise gelatine as ingredient and wherein the gelatine is set, e.g. for conferring the envisaged texture to the edible product, such as e.g. water jellies. For the gelatine to properly set in the edible product, the edible product is usually kept for a certain time period at a lower temperature in order to allow the gelatine to set or to accelerate the gelling. E.g. for common water jellies, the setting time is several hours, usually 16 hours at 4-10° C. Although the said setting time is shortened by keeping the edible product at such low temperature, the setting times are still undesirably long, not only for industrial purposes, but also in countries having a warm climate and where refrigeration space is rare. Also, it is desired to provide edible products that not only have a shorter setting time or a higher setting temperature, but that can also be prepared at a lower temperature of 35° C. or below.

It is known in the art to prepare a gelatine derivative by reacting gelatine at elevated temperature with a metaphosphoric acid, resulting in a chemical reaction and the formation of gelatine metaphosphate. The reaction takes place at elevated temperature. GB888,643 describes this chemical reaction to take place at 50° C. A metaphosphate can be used as starting material, but in such a case, a significant amount of a strong acid must be added in order to convert the phosphate into the phosphoric acid in order for the reaction to take place. Such a derivative can be used in order to reduce the setting time. U.S. Pat. No. 2,196,300 describes such gelatine metaphosphate to produce a firmer and faster setting marshmallow. U.S. Pat. No. 2,968,565 describes a chocolate chiffon having improved foam setting, comprising gelatine metaphosphate. However, for the gelatine metaphosphate to be formed, elevated temperature of at least 45° C. is necessary.

It has now surprisingly found that a combined preparation of gelatine and polyphosphate, without the need of reacting with one another to form the above-mentioned gelatine metaphosphate, i.e. as separate components, also result in a faster setting time and, in addition to that, to an elevation of setting temperature, without the need of forming a gelatine metaphosphate by chemical reaction, while the gelatine solution can be prepared at a low temperature of 35° C. or below.

Thereto, the invention is characterized in that a gelatine composition is provided, comprising cold soluble gelatine, i.e. gelatine capable of being dissolved in water having a temperature of 35° C. or less to a solution of at least 10 w/w % and polyphosphate. Such cold soluble gelatin may also be defined as amorphous gelatin as it has an amorphous structure, whereas the conventional gelatins have a partial crystalline structure. Such cold soluble gelatins behave like conventional gelatins that dissolve only at a temperature of 60° C. The main difference lies in the fact that cold soluble gelatins can be dissolved at 35° C. or lower, such as at 30° C. or lower, 25° C. or lower, 20° C. or lower. Cold soluble gelatine can be dissolved in an aqueous medium such as water, i.e. at least 10 w/w, in particular at least 15 w/w %, 20 w/w %, 25 w/w % or even 30 w/w %, i.e. similar to dissolution of conventional gelatins.

Sodium polyphosphates have the general formula Na₍ₙ₊₂₎PₙO₍₃ₙ₊₁₎. Their anions are composed of chains in which each phosphorus atom is linked to its neighbours through two oxygen atoms, thus forming a linear, unbranched structure; the degree of polymerization can take values from 2 to 10⁶.

The structure of linear polyphosphate is depicted below (M is Na⁺ when the polyphosphate is sodium polyphosphate).

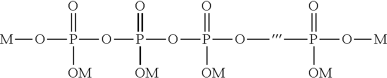

Sodium polyphosphate, also known as Graham's salt or sodium hexametaphosphate (SHMP), is obtained by melting NaH₂PO₄ and/or Na₂HPO₄ at 700-800° C. followed by rapid cooling. Although pure SHMP would be a hexamer (NaPO₃)₆, commercially available SHMP is typically a mixture of polymeric metaphosphates, of which the hexamer is one, and is usually the compound referred to by this name. It is more correctly termed sodium polymetaphosphate. Sodium polyphosphates available on the market usually consist of mixture of linear polyphosphates with different chain lengths; usually very small amounts of cyclophosphates and ultraphosphates (condensed high molecular weight phosphates) are present. SHMP hydrolyzes in aqueous solution, particularly under acidic conditions, to sodium trimetaphosphate and sodium orthophosphate. Although other polyphosphates may be used in the gelatine composition according to the invention, such as the potassium salt, the sodium salt is preferred.

SHMP is used as a sequestrant and has applications within a wide variety of industries, including as a food additive in which it is used under the E number E452i.

It has surprisingly found that in combination with polyphosphate, in particular sodium polyphosphate, the cold soluble gelatine has a faster setting time, and/or a higher setting temperature, without the need to be heated to the usual dissolution temperature of 60° C. This surprising finding makes it possible to prepare a plurality of gelatine comprising products that require the gelatine to set to be produced in a more efficient manner in view of time and temperature. In particular, products can be prepared with shorter setting time, while the product can be produced at a lower temperature, i.e. no need to dissolve the gelatine at a high temperature of 60° C. This means that edible products, comprising gelatine wherein the gelatine is set, can be produced in a faster manner and/or with less cooling.

The gelatine composition preferably comprises 90 w/w % or more, preferably 95 w/w % or more, and most preferably 97 w/w % or more gelatin, based on the total weight of the composition, and most preferably consists of gelatine and polyphosphate. Optionally other ingredients can be present, e.g. to improve the shelf life of the composition, such as preservatives, or to improve dissolution of the composition and prevent lump formation at dissolution, such as anti-caking and anti-lumping agents like sugar, or other ingredients tailored to the envisaged end product, such as antioxidants, nutrients, vitamins. Such other ingredients are preferably present in an amount of 0-5 w/w %, based on the total weight of the composition. The gelatine composition according to the invention can in particular be used for non-aerated edible products, such as water jellies, in the meat industry as jelly or binder material.

The gelatine composition preferably comprises 1.5-5 w/w % polyphosphate, based on the gelatine content, more preferably 1.5-3.5 w/w %, even more preferably 2.0-3.0 w/w %, still even more preferably 2.3-2.7 w/w %, and most preferably about 2.5 w/w %. With ‘about’, 5%, preferably 3%, more preferably 1% even more preferably 0.5% and most preferably 0% under or above the said indicated value, such as 2.5 w/w % is deemed to be allowed. The remainder is preferably gelatin, optionally also comprising other ingredients, e.g. as described above. In particular for edible products that should have a clear appearance, such as water jellies, the content of polyphosphate is preferably be in the above ranges, as a high content of polyphosphate may possibly result in a turbid appearance of the product.

The gelatine of the composition of the invention is preferably capable of being dissolved in water having a temperature between 15 and 35° C., preferably between 25 and 30° C. As indicated above, the solution, in particular an aqueous solution, to be prepared comprises at least 10 w/w gelatin, preferably at least 20 w/w % gelatine as indicated above.

The gelatine preferably has a bloom value of 200 or more, in particular a high Bloom gelatine as defined above, more preferably having a Bloom value of 240-275. Also for water jellies, a high Bloom value is advantageous, and can therefore be obtained by using gelatine of a lower Bloom value. By using gelatine of a very high Bloom value, improved functionalities can be obtained that were not possible before, such as setting at higher temperatures. Using a gelatine having a relatively low Bloom value of e.g. below 125 would result in unattractive soft jelly material, or the jelly material could lose its texture by slight temperature elevation.

Therefore, the invention also relates to ready-to-use mixes for the preparation of jelly desserts, such as water jellies, with and without sugar. To this end, the invention relates to a composition, comprising 1-3 parts per weight gelatin, preferably high Bloom gelatine and 0.015-0.15 parts per weight polyphosphate. Addition of the polyphosphate can however also be done at the application level, i.e. when preparing the mix used for the preparation of the product, such as a food. The mix can be provided as a mix of dry components, ready to be dissolved in water.

In a preferred embodiment, such composition also comprises 10-30 parts per weight sugar, in particular sucrose, the sugar possibly partly or completely replaced by a sweetener, where the amount of replaced sugar will preferably correspond in sweetening power with the replacing sweetener.

An even more preferred composition may also comprise 0.2-0.4 parts per weight acid, such as citric acid, and/or 0.02-0.04 parts per weight NaCl and/or 0.02-0.04 parts per weight trisodiumcitrate. Such compositions are intended to be mixed with water such, that the gelatine content will be 1-3 w/w % of the mixture. The composition can be dissolved in water of ambient temperature without the need of additional heating, and will result in a water jelly dessert.

In an attractive embodiment, the gelatine composition is a particulate, wherein the particle size of the particles comprising the polyphosphate corresponds with that of the particles comprising the gelatin. The said particle size is preferably expressed in mesh, which means that the particles of a certain mesh size pass through a sieve having the said mesh size. At a higher mesh size value, not all particles would pass. The mesh size used herein corresponds with that of the US standard ASTM E11:01. This means that for particles having a particle size of 60 mesh at least 95 w/w % would pass though a no. 60 mesh, i.e. having a mesh aperture size of 0.25 mm. Through a sieve of a higher number (i.e. with smaller apertures), not all of the particles that passed the no. 60 mesh sieve particles would pass. For the above preferred composition, the term ‘correspond’ would still allow a difference in particle size (diameter) of 0.15 mm, preferably of 0.10 mm, more preferably of 0.05 mm and most preferably of 0.0 mm. However, also dry mixes are possible wherein the particle size of these particles differ. Acceptable results have also been obtained with particulates, wherein the particle comprising polyphosphate had a size of 325 mesh (0.45 mm) and the particles comprising the gelatine had a size of 60 mesh (0.25 mm).

When both components (gelatine and polyphosphate) are included in the same particles, e.g. by dissolving both the gelatine and the polyphosphate in a single solution and subjecting the solution to a drying step where the dried material is rendered into particles of a desired size, a composition according to the invention is obtained, that has improved qualities as compared to a blended mixture of the components, and demixing of the separate components is avoided. Such gelatine composition can advantageously be used for any gelatine containing edible product, in particular non-aerated edible products such as water jellies.

When both the gelatine and the polyphosphate are of corresponding particle size, (or, as explained above, when both components are in the same particle) these both components can conveniently be mixed with other ingredients of edible products and will display similar distribution behavior. Preferably, the particle size of both components is preferably about 50-200 mesh (i.e. 0.30-0.07 mm), more preferably about 60-150 mesh (i.e. 0.25-0.11 mm) and most preferably about 60-100 mesh (i.e. 0.25-0.15 mm). Most preferably, both components have a particle size not differing more than 0.2 mm in diameter. With ‘about’, 5% under or above the said value is deemed to be allowed.

In a very attractive embodiment of the present invention, a gelatine composition as described above is used as ingredient for an edible product, in particular an edible product wherein the gelatine is set. More particularly, the gelatine composition of the invention is used as ingredient of a non-aerated edible product. The composition is preferably a particulate, the particles therein each comprising both the gelatine and the polyphosphate.

The term ‘edible’ product is intended to mean any product that can be consumed and digested by the human and animal body. In particular, the edible products are food products, e.g. having a nutritional value. However, dairy products and other products that contain calcium are less preferred, as it was observed that the presence of calcium results in insufficient gelling of the gelatin.

A non-aerated edible product is to be understood as an edible product wherein no significant amounts of air or other gas is introduced upon preparation thereof by e.g. whipping or by the aid of a blowing agent. The density of the ready edible product is more than, or similar to that of the mixture of the ingredients necessary to produce the edible product. Similar means not more than 10%, preferably not more than 5%, more preferably not more than 3% less density. For example, jellies are such non-aerated products, whereas e.g. chocolate mousses and marshmallows are aerated edible products.

In another embodiment, the invention provides an edible product, comprising the gelatine composition as described above.

The edible product is preferably food product, in particular a water jelly, although also other food products can be contemplated, as described above, such as aspic. Aspic is a gelatine composition usually comprising up to 15 w/w % gelatine, and is used to cover e.g. meat. The gelatine content can also be up to 10 w/w % or up to 5 w/w %, depending on the envisaged rigidity of the aspic. The aspic usually also contains flavors and acid.

The edible product of the invention preferably has pH of below 6, preferably below 5, more preferably between 3 and 4. Without being bound to any explanation, it is believed that a higher pH can be realised when using a gelatine composition according to the invention, as because of the presence of polyphosphate, less acid is necessary to arrive at similar and desired gelling properties as compared to when gelatine without polyphosphate is used. It has e.g. been found that a similar texture can be obtained for a state of the art water jelly without polyphosphates having a pH of 2.9 as compared to a water jelly with polyphosphates according to the invention having a pH of 3.5.

The edible product of the invention preferably comprises up to 25 w/w %, based on the food product, dry matter, preferably up to 20 w/w %, more preferably up to 15 w/w %, most preferably up to 10 w/w %. This means that the food product comprises at least 75, 80, 85 or 90 w/w % water, respectively. Above a dry matter content of 20 w/w %, it is observed that gelling may become impaired, probably as a result of limited water availability to form the required gel matrix.

In a particular embodiment, the edible product according to the invention comprises 1-20 w/w %, based on the food product, of the gelatine composition, preferably 1-15 w/w %, more preferably 1-10 w/w %. an attractive example of such a food product is aspic. In such a case, the weight of the food product is determined based o the total weight of the aspic, without taking into account the weight of the meat, covered by the aspic.

In a preferred embodiment, the edible product of the invention comprises 1.0-3.0 w/w %, based on the edible product, of the gelatine composition, preferably 1.0-2.5 w/w %, more preferably 1.2-1.8 w/w %, and most preferably 1.4-1.6 w/w %. Such edible product is e.g. water jelly.

Water jellies usually comprise 1-3 w/w % (based on the total recipe) high Bloom gelatin, 0.2-0.4 w/w % acid (in particular citric acid, citric acid anhydride and food grade salts thereof), 10-30 w/w % sugar, 0.02-0.04 w/w % sodium chloride and the required flavoring and coloring agents. It has been found that in particular for water jellies, the preparation is significantly improved as the setting temperature is higher and the setting time is shorter as compared with water jellies prepared without polyphosphate. The setting time can even be reduced from 16 hours to 8 hours. It has also been found that the acid content can be reduced when the polyphosphate is included for the same gelling properties, which is cost effective. The water jelly according to the invention preferably has a polyphosphate content of 0.015-0.15 w/w %. The cold soluble gelatine provides the additional advantage of being capable of preparing the edible product at lower temperatures, e.g. at ambient temperatures, at slightly elevated temperatures (of up to 40° C.) or even at the temperature of tap water. The present invention therefor provides an instant mix, with which an edible product, such as water jelly can be produced without the need of heating any of the ingredients. The mix is ready to use and can be mixed into the aqueous medium that already contains the additional ingredients, or whereto the said additional ingredients can be added later on. It is also possible that the mix comprises, in addition to the cold soluble gelatine and the polyphosphate, one or more or all of the additional envisaged ingredients, so that the mix is only mixed with a suitable amount of water.

Preferably, the said edible product is a water jelly. In case of water jelly, the pH of the edible product is preferably between 2.5 and 4, more preferably between 2.9 and 3.8. If acid content is lowered further (i.e. to a pH value of above 4) the water jelly may become turbid and firmness may decrease. If acid content is raised (i.e. to below pH 2.5) firmness and setting temperature may decrease.

Further, the invention relates to a method for the preparation of a gelatine composition as described above, in particular a particulate. Instead of e.g. dry mixing the cold soluble gelatine and the polyphosphate for the preparation of the gelatine composition of the invention, a gelatine and polyphosphate can be dissolved in a liquid medium, preferably an aqueous medium, to form a solution, and then form a particulate from the solution by drying, in particular by drum drying, resulting in uniform particles, wherein each of the particles may comprise both the components. By applying the drum drying technique, cold soluble gelatine can be obtained. Therefore, in step a., any gelatine can be used to obtain the gelatine solution, as long as during the preparation method, the gelatine is conferred into cold soluble gelatin, e.g. by application of the drum drying technique. It is also possible to prepare separate aqueous solutions of gelatin an polyphosphate that are mixed before drum drying step b. The pH in step a., and preferably in any step of the preparation method, is not lowered by addition of acid. Without any pH adjustment, a gelatin solution as described above, with or without the polyphosphate present, has a pH of about 5.5. The pH is kept at a value at above 5. The conditions of the preparation method are therefore such, that no chemical reaction between the gelatine and the polyphosphate take place. The skilled person is aware of suitable drying methods, and is capable of adjusting the particle size to any desired size. It has very surprisingly been found that particles obtained this way are soluble in aqueous media at low temperatures, such as ambient temperature. However, the gelatin also dissolves, albeit slower, at lower temperatures such as 15° C. (tap water temperature). This means that a composition according to the present invention produced this way can be dissolved in tap water or any aqueous medium, e.g. at ambient temperature, without the need of heating. This results in a significant advantage when preparing edible products, such as water jellies: as dissolution of the gelatine takes place at ambient temperature, less or even no time consuming cooling down of the solution has to be performed. Further, as discussed above, setting takes place at a relative high temperature, so that also from this point of view, less cooling is needed.

The invention will now be further explained by the following drawing and examples, which are however not intended to limit the scope of the claims.

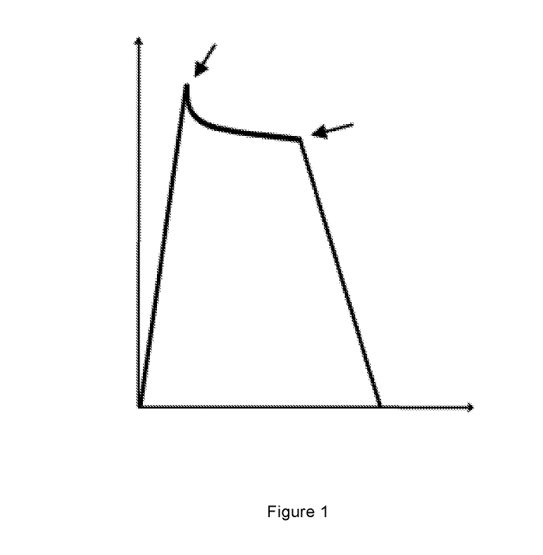

In the drawing, FIG. 1 shows a graph showing compression forces in time of a firmness test on different water jellies according to example 2. The percentages mentioned in the examples are weight percentages unless otherwise indicated.

### SAMPLES

### 1. Gelatine (Comparative Sample):

Cold soluble gelatine (Gelita® Instant Gelatine, Gelita, Germany)

### 2. Dry Blend of Gelatine and Polyphosphate

97.5% cold soluble gelatine (Gelita® Instant Gelatine, supra) with 2.5% Sodium Polyphosphate (Budit 6H, Chemische Fabrik Budenheim KG, Germany)

### 3. Drum-dried Blend of Gelatine and Polyphosphate:

An aqueous solution of 19.5 w/w % of classical pig skin gelatine (Rousselot® 250PS, Rousselot, Belgium) and 0.5 w/w % sodium polyphosphate (Budit 6H, supra) was prepared by dissolving both ingredients in water at 60° C. The pH of the solution was 5.5. The solution was dried on a drum dryer Model T 5/5 from the Goudsche Machine Fabriek (GMF, the Netherlands) using a stainless steel drum having a drying surface area of 1.5 m², a drum diameter of 50 cm and length of 50 cm at about 122° C., a rotation speed of 1 round per 55 seconds and a film thickness of 0.45 mm.

### EXAMPLE 1

### Water Jelly

### 1.1. Preparation of Water Jellies

### Comparative Sample 1 and Samples 2 and 3:

For 1 kg of final water jelly product, 15.4 g of sample 1, 2 or 3 and 126 g of sucrose (fine granulated sugar K1, Tiense Suiker, Belgium) are dissolved in 855 g of water at ambient temperature (25° C.). The solution is kept at ambient temperature during 30 minutes to completely dissolve the gelatine. After these 30 minutes, 3.0 g of citric acid monohydrate (fine granulated citric acid monohydrate food grade (E330), Jungbunzlauer, Germany), 0.3 g of sodium chloride (fine kitchen salt, Carrefour, Belgium) and 0.3 g of tri-sodium citrate (fine granulated trisodiumcitrate dihydrate food grade (E331), Jungbunzlauer, Germany) are mixed into the solution. At this point the necessary quantities of food colour and flavour are also added and mixed in at quantum satis.

### 1.2. Determination of Setting Temperature

Setting temperature is measured on the water jelly solution (before setting at low temperature). It is executed using a rheometer RS01 (Thermo-Fisher) equipped with a 35 mm/2° angle cone. The rheometer is used in oscillatory mode with the following setting:

| Temperature Descend Range | 45 to 2° | C. |
|---|---|---|
| Temperature Descend Rate | 1° | C./min |
| Shear Stress | 1 | Pa |
| Oscillatory Frequency | 0.1 | Hz |

The setting temperature is determined as the temperature (° C.) at equal values for the shear storage modulus G′ and the shear loss modulus G″. The shear storage modulus G′ represents the elastic behavior of a material. The shear loss modulus G″ represents the viscous behavior of a test material. For fluid or liquid state materials G″>G′, whereas for gel-like or solid state materials: G′>G″. At the setting temperature G′=G″. See also Thomas G. Mezger, The Rheology Handbook', 3rd revised edition, 2012, ISBN 3866308906.

1.3. Determination of Firmness after Jellification-Comparing Water Jellies made with Gelatine or with a Blend of Gelatine and Polyphosphate

140 g of the water jelly solutions of comparative sample 1 and samples 2 and 3 were poured into cylindrical plastic boxes with a diameter of 75 mm and a height of 45 mm, where after the boxes were closed with a matching lid, and allowed to set at 4° C. for 24 hours.

As a measure for texture, the firmness of the water jellies is measured on the filled moulds after jellification, the test is executed immediately after removing the samples from the cold chamber and the lids are removed prior to the analyses.

The analyses are executed using a TAX-T2i texture analyser (Stable Micro Systems) equipped with a P/1R probe and a load cell of 5 kg. The forces are measured in compression/hold until time mode with the following settings:

| | |
|---|---|
| Pre Test Speed | 2 mm/s |
| Test Speed | 1 mm/s |
| Trigger Force | 5 g |
| Distance | 6 mm |
| Time | 60 s |
| Post Test Speed | 5 mm/s |

The forces (g) measured are plotted in time (s), for each sample resulting in a curve having the shape as shown in FIG. 1, wherein the force is on the Y-axis, the time on the X-axis. The firmness (g) corresponds to the first peak (1) shown in FIG. 1 by the left arrow. The sudden drop, shown by the right arrow depicts the end of the measurement, i.e. after 60 seconds when the plunger is removed from the jelly sample. The value reported below is the average of at least 2 measurements on different moulds.

| | | Setting | Firmness | Firmness | Firmness |
|---|---|---|---|---|---|
| | | Temperature | after 7 | after 16 | after 24 |
| Gelatine | Short | of the Water | hours of | hours of | hours of |
| (see | description of | Jelly solution | jellification | jellification | jellification |
| specifications) | used gelatine | (° C.) | (g) | (g) | (g) |
| 1 | Cold Soluble | 5.6 | 57 | 73 | 75 |
| | Gelatine | | | | |
| 2 | Dry blend of | 8.7 | 64 | 81 | 88 |
| | cold soluble | | | | |
| | gelatine + | | | | |
| | sodium | | | | |
| | polyphosphate | | | | |
| 3 | Drum dried | 7.1 | 67 | 86 | 93 |
| | blend of | | | | |
| | Rousselot ® | | | | |
| | 250PS + | | | | |
| | sodium | | | | |
| | polyphosphate | | | | |

Conclusions: Using the dry blend of the invention and the drum dried blend of the invention in water jelly application, where the preparation temperatures did not exceed 40° C. results in an increase of the setting temperature of the water jelly solution and to a decrease in the jellification time needed to obtain the same firmness.

### EXAMPLE 2

### Aspic

Aspic was produced by dissolving 100 g of the dry gelatin composition of sample 3 in 1 liter of water at ambient temperature. The following flavors were added in the following amount:

Further edible acid was added in an amount, resulting in a pH of the aspic of 4. The solution was casted on pâté, resulting, after setting, in a firm gel layer on top of the pâté. The solution was also used for embedding pieces of meat or fish, and of pieces of vegetables or fruit. Depending on the envisaged taste, the solution was in some instances enriched by the addition of flavors, such as sweet or savory flavors, such as bullion or meat flavors. Similar results were obtained when a gelatin composition of sample 1 or 2 was used. However, the setting time was significantly shorter when sample 2 or 3 was used as compared to sample 1.

1. Gelatine composition, comprising gelatin, capable of being dissolved in water having a temperature of 35° C. or less to a solution of at least 10 w/w %, and polyphosphate.

2. Gelatine composition according to claim 1, comprising 90 w/w % or more gelatin, based on the total weight of the composition,

3. Gelatine composition according to claim 1 or 2, comprising 95 w/w % or more, preferably 97 w/w % gelatin, and more preferably consists of gelatine and polyphosphate.

4. Gelatine composition according to any of the preceding claims, comprising 1.5-5 w/w % polyphosphate, based on the gelatine content.

5. Gelatine composition according to claim 4, comprising 1.5-3.5 w/w % polyphosphate, preferably 2.0-3.0 w/w % polyphosphate, more preferably 2.3-2.7 w/w %, most preferably about 2.5 w/w %.

6. Gelatine composition according to any of the preceding claims, wherein the temperature is between 15 and 35° C., preferably between 25 and 30° C.

7. Gelatine composition according to any of the preceding claims, wherein the gelatine has a Bloom value of 200 or more, preferably of 225-325, most preferably of 240-275.

8. Gelatine composition according to any of the preceding claims, wherein the polyphosphate comprises sodium.

9. Gelatine composition according to claim 8, wherein the sodium polyphosphate comprises sodiumhexametaphosphate (SHMP).

10. Gelatine composition according to any of the preceding claims, comprising 1-3 parts per weight gelatin, and 0.015-0.15 parts per weight polyphosphate.

11. Gelatine composition according to any of the preceding claims, further comprising 10-30 parts per weight sugar.

12. Gelatine composition according to any of the preceding claims, further comprising:
0.2-0.4 parts per weight acid, in particular citric acid, and/or
0.02-0.04 parts per weight NaCl and/or
0.02-0.04 parts per weight trisodiumcitrate.

13. Gelatine composition according to any of the preceding claims, wherein the composition is a particulate, wherein the particle size of the particles comprising the polyphosphate corresponds with that of the particles comprising the gelatin.

14. Gelatine composition according to any of the preceding claims, wherein the composition is a particulate, the particles of the particulate each comprising both the gelatine and the polyphosphate.

15. Gelatine composition according to any of claim 13 or 14, having a particle size of about 50-200 mesh (i.e. 0.30-0.07 mm), preferably of about 60-150 mesh (i.e. 0.25-0.11 mm) and more preferably of about 60-100 mesh (i.e. 0.25-0.15 mm).

16. Use of a gelatine composition according to any of the preceding claims, as ingredient for an edible product.

17. Use according to claim 16, wherein the edible product is a non-aerated edible product wherein the gelatine is set.

18. Edible product, comprising the gelatine composition of any of the claims 1-15.

19. Edible product according to claim 18, being a food product.

20. Edible product according to claim 18 or 19, having a pH of below 6, preferably below 5, more preferably between 3 and 4.

21. Edible product according to any of the claims 18-20, comprising up to 25 w/w %, based on the food product, dry matter, preferably up to 20 w/w %, more preferably up to 15 w/w %, most preferably up to 10 w/w %.

22. Edible product according to any of the claims 18-21, comprising 1-20 w/w %, based on the food product, of the gelatine composition, preferably 1-15 w/w %, more preferably 1-10 w/w %.

23. Edible product according claim 21, comprising 1.0-3.0 w/w %, based on the food product, of the gelatine composition, preferably 1.2-1.8 w/w %, more preferably 1.4-1.6 w/w %.

24. Edible product according to claim 22, being a water jelly.

25. Method for the preparation of a gelatine composition according to any of the claims 1-12, comprising the steps of:
a. dissolving a gelatine and polyphosphate in an aqueous medium, to form a solution,
b. drum-drying the solution of step a. under the formation of a particulate.

26. Method for the preparation of an edible product according to any of the claims 18-23, comprising the steps of:
a. dissolving the gelatine and polyphosphate in an aqueous medium, and optionally adding additional ingredients, to form a solution,
b. allowing the gelatine to set.

27. Method according to claim 25, wherein the temperature in step a. is 35° C. or less, preferably between 15 and 35° C., more preferably between 25 and 30° C.

28. Method according to claim 25 or 26, wherein the said temperature is not exceeded during the preparation of the edible product.
